(19) United States
(12) Patent Application Publication
(10) Pub. No.: US 2006/0087652 A1
(43) Pub. Date: Apr. 27, 2006

(54) Method for determining properties of a fibrous suspension

(75) Inventors: Niels Hardt, Heidenheim (DE); Michael Schwarz, Heidenheim (DE)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 11/256,974

(22) Filed: Oct. 25, 2005

(30) Foreign Application Priority Data
Oct. 26, 2004 (DE) 10 2004 051 960.9

(51) Int. Cl. G01N 21/00

(52) U.S. Cl. 356/338

(57) ABSTRACT

Method and a sensor for determining measured values of properties of a suspension in a machine for producing a fibrous web, in which light interacts with the fibrous suspension. The sensor picking up a scattered light signal and a transmitted light signal and measured values of at least one property are determined by evaluating the scattered light signal and the transmitted light signal.

### CROSS-REFERENCE TO RELATED APPLICATIONS

The present application claims priority under 35 U.S.C. § 119 of German Patent Application No. 10 2004 051 960.9 filed Oct. 26, 2004 the disclosure of which is expressly incorporated by reference herein in its entirety.

### BACKGROUND OF THE INVENTION

1. Field of the Invention

The invention relates to a method for determining measured values of properties of a suspension in a machine for producing and/or finishing a fibrous web, in particular paper, via a sensor in which light interacts with the suspension. The invention also relates to a sensor and a machine for producing and/or finishing a fibrous web.

2. Discussion of Background Information

The prior art discloses substantially two optical methods for measuring properties, in particular the consistency and the ash content, of a fibrous suspension in a machine for producing and/or finishing a fibrous web.

In the first method, properties of the suspension are measured with transmitted light, in the second method with scattered light.

In the case of the transmitted light measurement, measurements are generally carried out monochromatically. The transmitter and the receiver are about 1.5 to 3 mm from each other, so that the suspension located between them can be measured. In the transmitted light method, put loosely, “shadows” of particles in the suspension are measured. The transmitted light measurement is independent of the type of particle. Because of a small measuring window, the light beam has a diameter between 0.2 mm and 0.5 mm; the transmitted light measuring method depends highly on the flocculation and on the flow of the suspension, which means that measurement errors can arise.

In the case of scattered light measurement, the light scattered back by particles from a large but undefined volume region in the suspension is measured. The scattered light measurement depends highly on the type of particle and their scattering intensity.

### SUMMARY OF THE INVENTION

The present invention provides a method with which properties of a suspension can be determined with high accuracy over a wider measurement range than in the known methods. Furthermore, the present invention provides an appropriate sensor.

In accordance with the invention, a method for determining measured values of properties of a suspension in a machine for producing a fibrous web utilizes a sensor in which light interacts with the fibrous suspension. The sensor picks up a scattered light signal and a transmitted light signal, such that measured values of at least one property are determined by evaluating the scattered light signal and the transmitted light signal.

The invention is based on the idea of determining measured values of the at least one property more accurately in that signals from different measurement principles, the scattered light measurement and the transmitted light measurement, having a different information content with respect to the same property of the suspension, are combined. As a result, the information content on the basis of the signal values is increased in order to determine the measured values of the at least one property, as a result of which this property can be determined more accurately. In this case, even “erroneous” signals from the one measurement principle are detected and eliminated by “correct” signals from the other measurement principle during the determination of measured values of the at least one property of the suspension.

This makes it possible to combine advantages of the two measurement principles and to eliminate disadvantages.

Advantageous refinements and developments of the invention are specified below.

For optimal control during the production of fibrous webs, in particular paper, it is important to know a number of properties of the suspensions in a paper machine. For example, the consistency and the ash content are particularly important. Accordingly, a preferred embodiment provides for measured values of two properties, in particular the consistency and the ash content, to be determined by evaluating the scattered light signal and the transmitted light signal.

With the method according to the invention, however, measured values of other properties of a suspension, such as the proportion of fines or the like, can also be determined.

In particular for the purpose of method and process control during the production of the fibrous web, it is expedient if measured values of a property of the fibrous web are measured during operation, that is to say if the suspension does not have to be removed from the production circuit in order to measure the at least one property. Accordingly, a particularly preferred embodiment of the invention provides for the measurement to be carried out online, in particular in a pipeline carrying the suspension which is connected to the production circuit.

In order to increase the ability to evaluate the measured signals statistically, a further refinement of the invention provides for the scattered signal and the transmitted light signal to be recorded at high resolution, in particular with a sampling rate of more than 2 kHz, preferably of more than 4 kHz.

By the method according to the invention, the measured values of the consistency are preferably determined with a measurement accuracy of 0.005% to 0.01% in a range from 0.01% to 4.0%.

Furthermore, through the method according to the invention, the measured values of the ash content are determined with a measurement accuracy of 0.005% to 0.01% in a range from 0.01% to 1.0%.

In order to increase the measurement accuracy and the measurement range, a preferred refinement of the invention provides for the scattered light signal and the transmitted light signal to be measured at a plurality of and/or at different wavelengths. This can mean that the scattered light signal and/or the transmitted light signal are measured at one discrete wavelength or a plurality of discrete wavelengths or in a wavelength range. Provision is therefore preferably made for the scattered light signal to be measured at wavelengths from the range from 250 nm to 1000 nm and for the transmitted light signal to be measured at wavelengths from the range from 600 nm to 1000 nm.

The sensor is preferably calibrated by using laboratory measured values of the at least one property. In this way, deviations of the measured data measured by the sensor can be corrected immediately and simply, for example automatically.

If two properties of the suspension are to be determined, it is expedient if the sensor is calibrated by using laboratory measured values of two properties, in particular of the consistency and of the ash content.

In an advantageous development of the method, further process information and/or further measured values are used for the purpose of calibration. This means that the measured values of the at least one property that are determined by the sensor can be weighted and corrected by using values determined by other sensors. As a result, dependences of a variable measured by one sensor on other process information and/or measured values can be taken into account. In this case, for example a drift of measured values over time can also be taken into account in that values measured immediately before the current measured values are incorporated more significantly into the correction than earlier measured values.

Particularly preferably, measured values of the at least one property are determined in the head box and/or in the water led away from the wire section and/or in the water led away from the press section. On the basis of these measured values, the production process can be controlled optimally.

In order to be able to register production fluctuations in the cross machine direction as well, a preferred embodiment of the invention provides for measured values of the at least one property to be determined section by section over the machine width.

It proves to be particularly suitable if the calibration is carried out with the following multivariate regression methods: partial least square regression (PLSR) or principal component regression (PCR). These methods are generally known. As proof, reference is made here by way of example to the book “Multivariate Calibration” by H. Martens, T. Naes; John Wiley & Son, Chichester, N.Y., Brisbane, Toronto, Singapore, 1998. In the latter, for example, principal component regression (PCR) is described.

The calibration of the sensor is preferably carried out at a predefined time interval. In this way, changes in the measured values over the course of time are kept within a specific band.

The invention further relates to a sensor for determining measured values of properties of a suspension in a machine for producing a fibrous web, in which light interacts with the suspension, which is characterized in that the sensor has a scattered light measuring unit and a transmitted light measuring unit, whose signals can be fed to a common evaluation unit.

This provides a sensor which picks up a scattered light signal and a transmitted light signal and determines the measured values of at least one property by evaluating the scattered light signal and the transmitted light signal.

In order to be able to construct the sensor to be as compact as possible and insensitive with respect to ambient conditions, it is advantageous if the scattered light measuring unit and the transmitted light measuring unit are combined in one housing.

The invention further relates to a machine for producing and/or finishing a fibrous web, having a sensor according to the invention.

In order to be able to carry out online measurements, the sensor is arranged in a pipeline carrying a suspension, in particular a line with through flow.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a sensor according to the invention with which the method according to the invention can be carried out; and

FIG. 2 shows a paper machine having sensors according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention, In this regard, no attempt is made to show structural details of the present invention in more detail than is necessary for the fundamental understanding of the present invention, the description taken with the drawings making apparent to those skilled in the art how the several forms of the present invention may be embodied in practice.

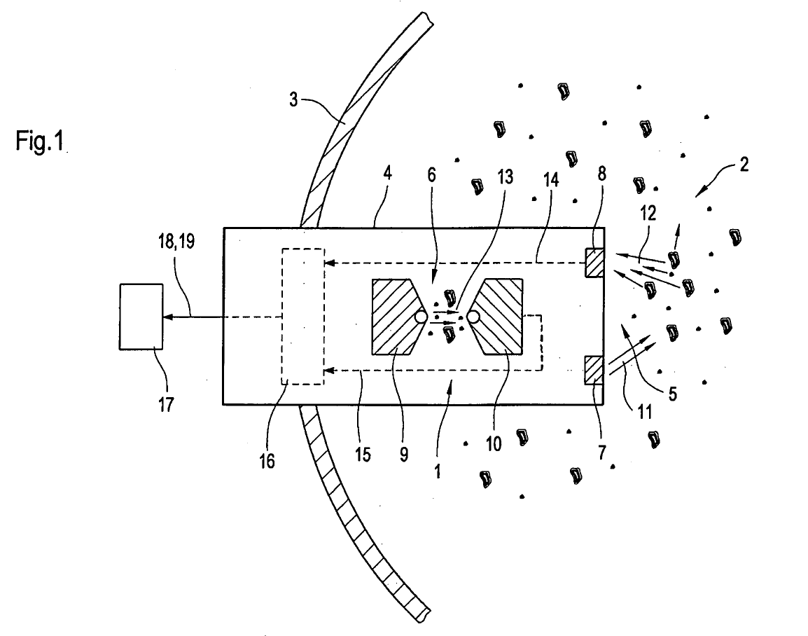

FIG. 1 shows a sensor 1 according to the invention, which is installed in a pipeline 3 carrying a suspension 2, in side view.

Only a section of the pipeline 3 is shown. As can be seen, the sensor 1 points laterally into the pipeline 3 through which the suspension 2 flows (the flow direction is perpendicular to the plane of the drawing).

The sensor has a sensor housing 4. The components located on the outside in the region of the sensor housing 4 are illustrated as hatched in the illustration of FIG. 1. The components located within the sensor housing 4 are illustrated dashed.

The sensor has a scattered light measuring unit 5 and a transmitted light measuring unit 6. The scattered light measuring unit 5 and the transmitted light measuring unit 6 are combined in a housing, namely the sensor housing 4, in the sensor 1 according to the invention.

The scattered light unit 5 has a transmitter 7 and a receiver 8. The transmitter 7 emits light 11 at a discrete wavelength or at a plurality of discrete wavelengths or in one or more wavelength range(s) into the half space extending in front of it. The discrete wavelengths or the wavelength range or ranges in this case originate from a wavelength range from 250 nm to 1000 nm. The light 11 interacts with the suspension 2 and the scattered light 12 which is produced during the interaction and which is oriented in the direction of the receiver 8 is detected by the receiver 8 as the scattered light signal 14.

The transmitted light unit 6 has a transmitter 9 and a receiver 10. The transmitter 9 emits light 13 aimed in the direction of the receiver 10, the intensity of light being attenuated as a result of interaction with the suspension 2 and being detected by the receiver 10 as the transmitted light signal 15. The light is emitted at a discrete wavelength or at a plurality of discrete wavelengths or in one or more wavelength range(s). The discrete wavelength(s) or the wavelength range(s) in this case originate from a wavelength range from 600 nm to 1000 nm.

In order to determine measured values 18 of the consistency and measured values 19 of the ash content of the suspension 2, the scattered light signal 14 picked up by the detector 8 and the transmitted light signal 15 picked up by the detector 10 are fed to an evaluation unit 16. In the evaluation unit 16, measured values 18 of the consistency and measured values 19 of the ash content of the suspension 2 are then determined by evaluating the scattered light signal 14 and the transmitted light signal 15.

On account of arranging the sensor in the pipeline 3 through which the suspension 2 flows, and on account of the fact that the sensor is designed in such a way that the latter can carry out at least one measurement per second, the measurements can be carried out online.

The sensor 1 is designed in such a way that the scattered signal 14 and the transmitted light signal 15 can be picked up with high resolution, in particular with a sampling rate of more than 2 kHz, preferably of more than 4 kHz. Thus, statistical outliers can be filtered out.

With the sensor 1 according to the invention, measured values 18 of the consistency can be determined with a measurement accuracy of 0.005% to 0.01% in a range from 0.01% to 4.0%. Furthermore, with the sensor 1 according to the invention, measured values 19 of the ash content are determined with a measurement accuracy of 0.005% to 0.01% in a range from 0.01% to 1.0%.

Furthermore, the sensor 1 is calibrated by using laboratory measured values of the consistency and of the ash content of the suspension 2. In this way, deviations of the measured data 18, 19 measured by the sensor 1 can be corrected immediately and simply, for example automatically. The calibration is carried out here by a multivariate regression, for example by partial least square regression (PLSR).

In order to calibrate the sensor 1, furthermore further process information and/or further measured values, such as properties of the fibrous web produced or the like, are used.

The measured values 18, 19 are fed to an open-loop and/or closed-loop control unit 17 of a paper machine.

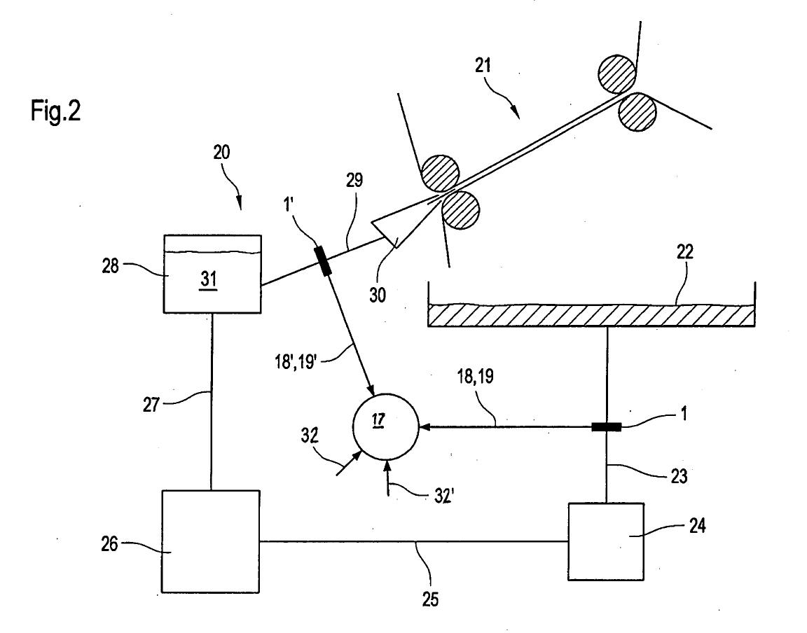

FIG. 2 shows a section of a paper machine 20 having two sensors 1 and 1′ according to the invention.

The white water 22 passing out of the wire section 21 is supplied via a pipeline 23 to a white water chest 24. In the pipeline there is arranged one of the sensors 1, with which online measured data 18, 19 of the consistency and of the ash content in the white water 22 are measured.

The white water 22 is led from the white water chest 24 via a pipeline 25 to the stock preparation 26. The fibrous suspension 31 produced in the stock preparation 26 passes via a pipeline 27 into the machine chest 28 and from there is fed via a pipeline 29 to a head box 30 in the wire section 21 of the paper machine 20.

In the pipeline 29, the other sensor 1′ is positioned to transmit and receive signals related to online measured data 18′, 19′ of the consistency and ash content in the fibrous suspension 31.

The measured data 18, 19 and 18′, 19′ measured by the two sensors 1 and 1′ is fed to the control and/or evaluation unit 17 of the paper machine 20, which controls and regulates the paper machine 20 on the basis of the measured values 18, 19, 18′ and 19′ and on the basis of further data 32, 32′.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for determining measured values of properties of a suspension in a machine for producing a fibrous web by means of a sensor in which light interacts with the suspension, wherein the sensor picks up a scattered light signal and a transmitted light signal and wherein measured values of at least one property are determined by evaluating the scattered light signal and the transmitted light signal.

2. The method as claimed in claim 1, wherein measured values of two properties, in particular the consistency and the ash content, are determined by evaluating the scattered light signal and the transmitted light signal.

3. The method as claimed in claim 1, wherein the measurement is carried out online.

4. The method as claimed in claim 1, wherein the scattered signal and the transmitted light signal are recorded at high resolution, in particular with a sampling rate of 2 kHz, preferably of more than 4 kHz.

5. The method as claimed in claim 1, wherein the measured values of the consistency are determined with a measurement accuracy of 0.005% to 0.01% in a range from 0.01% to 4.0%.

6. The method has claimed in claim 1, wherein the measured values of the ash content are determined with a measurement accuracy of 0.005% to 0.01% in a range from 0.01% to 1.0%.

7. The method as claimed in claim 1, wherein the scattered light signal is measured at wavelengths from the range from 250 nm to 1000 nm and the transmitted light signal is measured at wavelengths from the range from 600 nm to 1000 nm.

8. The method as claimed in claim 1, wherein the sensor is calibrated by using laboratory measured values of the at least one property.

9. The method as claimed in claim 8, wherein the sensor is calibrated by using laboratory measured values of two properties, in particular of the consistency and of the ash content.

10. The method as claimed in claim 8, wherein process information and/or further measured values are used for the purpose of calibration.

11. The method as claimed in claim 1, wherein the measured values of the at least one property are determined in the head box and/or in the water led away from the wire section and/or in the water led away from the press section.

12. The method as claimed in claim 1, wherein the measured values of the at least one property are measured section by section over the machine width.

13. The method as claimed claim 8, wherein the calibration is carried out by means of a multivariate regression, in particular by means of partial least square regression (PLSR) or principal component regression (PCR).

14. The method as claimed in claim 8, wherein the calibration of the sensor is carried out at a predefined time interval.

15. A sensor for determining measured values of properties of a suspension in a machine for producing a fibrous web, in which light interacts with the suspension, wherein the sensor has a scattered light measuring unit and a transmitted light measuring unit, whose signals can be fed to a common evaluation unit.

16. The sensor as claimed in claim 15, wherein the scattered light measuring unit and the transmitted light measuring unit are combined in a housing.

17. A machine for producing and/or finishing a fibrous web, having a sensor as claimed in claim 14.

18. The machine as claimed in claim 17, wherein the sensor is arranged in a pipeline carrying a suspension, in particular a line with through flow.
